(19) United States
(12) Patent Application Publication
(10) Pub. No.: US 2023/0038500 A1
(43) Pub. Date: Feb. 9, 2023

(54) ENHANCED DRX OPERATION FOR POWER SAVING WHEN THERE IS NO UPLINK DATA FOR TRANSMISSION

(71) Applicant: MEDIATEK INC., Hsin-Chu (TW)

(72) Inventors: Guan-Yu Lin, Hsin-Chu (TW); Chia-Chun Hsu, Hsin-Ch (TW)

(21) Appl. No.: 17/863,121

(22) Filed: Jul. 12, 2022

Related U.S. Application Data
(60) Provisional application No. 63/230,139, filed on Aug. 6, 2021.

(51) Int. Cl. H04W 52/02; H04W 76/28; H04W 76/27

(52) U.S. Cl. CPC H04W 52/0216; H04W 76/28; H04W 76/27

(57) ABSTRACT

A method of enhanced discontinuous reception (DRX) operation for additional power saving is proposed. A UE is allowed to not restart the DRX inactivity timer if there is no uplink data available to transmit, even when the UE receives a dynamic uplink grant. The UE thus can terminate the DRX active time and go to sleep earlier when the inactivity timer expires. The UE can send a sync message to inform the gNB of “not restarting the inactivity timer”, or the UE can send information for the gNB to know when the DRX active time will be terminated. Furthermore, the UE is allowed to request for dynamic DRX active time termination, e.g., to dynamically request for terminating the DRX active time earlier by sending a request or a notification to the network.

### CROSS REFERENCE TO RELATED APPLICATIONS

This application claims priority under 35 U.S.C. § 119 from U.S. Provisional Application No. 63/230,139 entitled “Enhanced DRX operation for Power Saving when there is no uplink data for Transmission,” filed on Aug. 6, 2021, the subject matter of which is incorporated herein by reference.

### TECHNICAL FIELD

The disclosed embodiments relate generally to connected mode discontinuous reception (DRX), and, more particularly, to DRX timer operation for power saving when there is no uplink data for transmission.

### BACKGROUND

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs) according to a predefined radio frame format. Typically, the radio frame format contains a sequence of radio frames, each radio frame having the same frame length with the same number of subframes. The subframes are configured for UE to perform uplink (UL) transmission or downlink (DL) reception in different Duplexing methods. Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE networks, Physical Downlink Control Channel (PDCCH) is used for dynamic downlink scheduling.

To enable reasonable UE battery consumption, discontinuous reception (DRX) operation in E-UTRAN is defined. UE may be configured via radio resource control (RRC) signalling with a DRX functionality that controls the UE's PDCCH monitoring activity for UE's C-RNTI, TPC-PUCCH-RNTI, TPC-PUSCH-RNTI and Semi-Persistent Scheduling C-RNTI (if configured). When in RRC_CONNECTED mode, if DRX is configured, UE is allowed to monitor the PDCCH discontinuously using the DRX operation. Otherwise, UE monitors the PDCCH continuously. The DRX parameters are configured by eNodeB, a trade-off between UE battery saving and latency reduction.

The following definitions may apply to DRX operation in E-UTRAN: 1) on-duration: a duration in downlink subframes in the start of each DRX cycles, during which it is mandatory for UE to monitor PDCCH. If the UE successfully decodes a PDCCH indicating new UL or DL transmission, the UE stays awake and starts the inactivity timer; 2) inactivity-timer: timer length of inactivity timer indicates the time duration in downlink subframes after UE successfully decode a PDCCH indicating a new UL or new DL transmission. The UE shall restart the inactivity timer following a single successful decoding of a PDCCH indicating a new UL or a new DL transmission; 3) active-time: the total duration that the UE is awake to monitor PDCCH. This includes the “on-duration” of the DRX cycle, the time UE is performing continuous reception while the inactivity timer has not expired, and the time UE is performing continuous reception while waiting for a DL retransmission after one HARQ RTT. Based on the above, the minimum active time is of length equal to on-duration, and the maximum active time is undefined.

In legacy DRX operation, when a UE receives a PDCCH indicating a new transmission for DL or UL, the UE will start or restart inactivity timer after the PDCCH reception. When inactivity timer is running, UE would stay in active time, i.e., monitor PDCCH occasion for possible UL or DL scheduling. Due to BS's aggressive dynamic UL grant scheduling (e.g., pre-grant, pre-scheduling), a UE without uplink data still need to stay in DRX active time, which causes unnecessary power consumption. For example, to reduce packet latency (e.g., for URLLC service), BS may frequently schedule UL resource for a UE. Regardless of whether UE has uplink data to transmit, as long as UE receives a dynamic grant, UE should (re)start inactivity timer and stay in DRX active time.

An enhanced DRX operation is sought for power saving when there is no uplink data.

### SUMMARY

A method of enhanced discontinuous reception (DRX) operation for additional power saving is proposed. A UE is allowed to not restart the DRX inactivity timer if there is no uplink data available to transmit, even when the UE receives a dynamic uplink grant. The UE thus can terminate the DRX active time and go to sleep earlier when the inactivity timer expires. The UE can send a sync message to inform the gNB of “not restarting the inactivity timer”, or the UE can send information for the gNB to know when the DRX active time will be terminated. Furthermore, the UE is allowed to request for dynamic DRX active time termination, e.g., to dynamically request for terminating the DRX active time earlier by sending a request or a notification to the network.

In one embodiment, a UE configures discontinuous reception (DRX) parameters for DRX operation in radio resource control (RRC) connected mode. The UE is configured with an inactivity timer. The UE monitors a physical downlink control channel (PDCCH) during a DRX ACTIVE time. The PDCCH carries a downlink control information (DCI). The UE continues to run the inactivity timer when the DCI indicates a physical uplink shared channel (PUSCH) transmission on an uplink grant. The UE determines that the UE has no uplink data available for transmission on the uplink grant. The UE terminates the DRX ACTIVE time based at least on expiry of the inactivity timer.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network supporting enhanced discontinuous reception (DRX) operation for UE power saving in accordance with one novel aspect.

FIG. 2 illustrates simplified block diagrams of a base station and a user equipment in accordance with embodiments of the present invention.

FIG. 3 illustrates a first solution of UE skips UL grants due to no UL data for transmission and UE does not (re)starting of inactivity timer to terminate DRX ACTIVE time and go to sleep earlier.

FIG. 4 illustrates a signaling flow between gNB and UE for not (re)starting inactivity timer upon receiving UL grant during DRX operation for power saving.

FIG. 5 illustrates a second solution of UE does not (re)starting of inactivity timer upon receiving UL grants and UE provides an explicit indication to the base station.

FIG. 6 illustrates a signaling flow between a base station and a UE for not restarting inactivity timer during DRX operation with explicit UE request or notification to the network.

FIG. 7 is a flow chart of a method of enhanced DRX operation for UE power saving in accordance with one novel aspect.

### DETAILED DESCRIPTION

Reference will now be made in detail to some embodiments of the invention, examples of which are illustrated in the accompanying drawings.

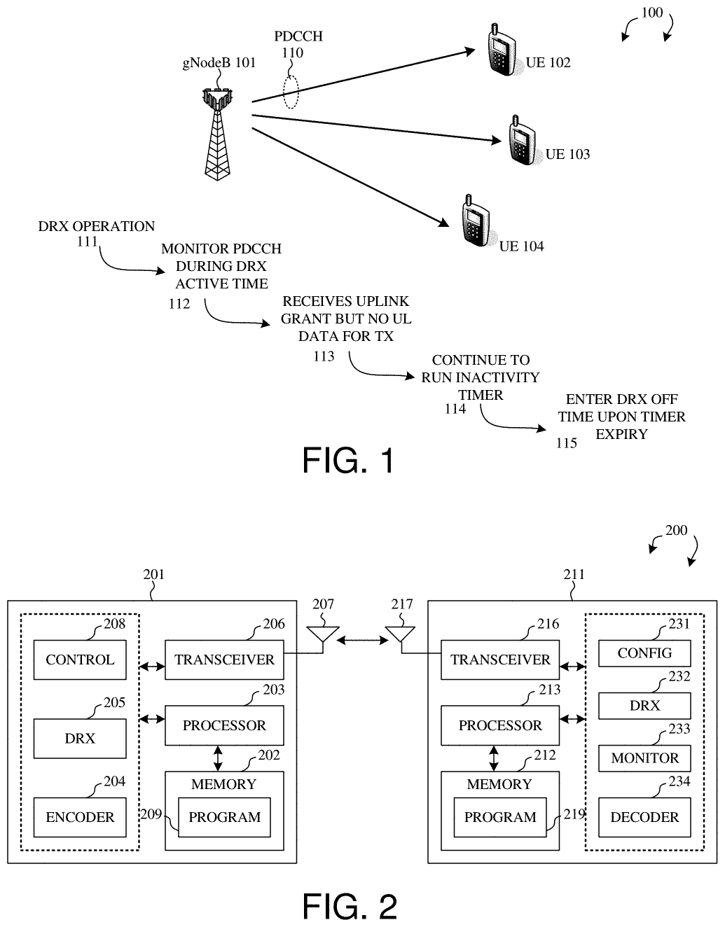

FIG. 1 illustrates a mobile communication network 100 supporting enhanced discontinuous reception (DRX) operation for UE power saving in accordance with one novel aspect. Mobile communication network 100 is an OFDM/OFDMA system comprising a base station gNodeB 101 and a plurality of user equipment UE 102, UE 103, and UE 104. When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. The UE gets the downlink or uplink scheduling information from a physical downlink control channel (PDCCH) that is targeted specifically to that UE. In addition, broadcast control information is also sent in PDCCH to all UEs in a cell. The downlink or uplink scheduling information and the broadcast control information, carried by PDCCH, is referred to as downlink control information (DCI).

To enable reasonable UE battery consumption, discontinuous reception (DRX) operation in E-UTRAN is defined. UE may be configured via radio resource control (RRC) signalling with a DRX functionality that controls the UE's PDCCH monitoring activity. When in RRC_CONNECTED mode, if DRX is configured, UE is allowed to monitor the PDCCH discontinuously using the DRX operation. Otherwise, UE monitors the PDCCH continuously. The DRX parameters are configured by gNodeB, a trade-off between UE battery saving and latency reduction.

In legacy DRX operation, when a UE receives a PDCCH indicating a new transmission for DL or UL, the UE will start or restart inactivity timer after the PDCCH reception. When inactivity timer is running, UE would stay in active time, i.e., monitor PDCCH occasion for possible UL or DL scheduling. Due to BS's aggressive dynamic UL grant scheduling (e.g., pre-grant, pre-scheduling), a UE without uplink data still need to stay in DRX active time, which causes unnecessary power consumption. For example, to reduce packet latency (e.g., for URLLC service), gNB may frequently schedule UL resource for a UE. Regardless of whether UE has uplink data to transmit, as long as UE receives a dynamic grant, UE should (re)start inactivity timer and stay in DRX active time.

In accordance with one novel aspect, an enhanced DRX operation is proposed for UE power saving. A UE is allowed to not restart the inactivity timer if there is no uplink data to transmit, even when UE receives a dynamic grant. The UE can send a sync message to inform gNB of “not restarting the inactivity timer”, or the UE can send information for gNB to know when DRX active time would be terminated. Furthermore, the UE is allowed to request for dynamic DRX active time termination, e.g., to dynamically request for terminating DRX active time earlier by sending a request or notification to the network. In the example of FIG. 1, UE 102 establishes an RRC connection with gNB 101 and enters DRX operation for power saving (111). UE 102 monitors PDCCH 110 during DRX ACTIVE time (112). UE 102 then receives an uplink grant. However, UE 102 determines that it has no uplink data available for transmission (113). In response to the determination, UE 102 does not (re)start the inactivity timer (114). Upon expiry of the inactivity timer (and satisfying other conditions), UE 102 enters DRX OFF time and goes to sleep for power saving (115).

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules and circuits to carry out some embodiments of the present invention. The different functional modules and circuits can be configured and implemented by software, firmware, hardware, or any combination thereof. The function modules and circuits, when executed by the processors 203 and 213 (e.g., via executing program codes 209 and 219), for example, allow base station 201 to encode and transmit downlink control information to UE 211, and allow UE 211 to receive and decode the downlink control information and to perform DRX operation accordingly.

In one example, base station 201 configures for PDCCH transmission via control module 208, configures for DRX operation via DRX module 205. The downlink control information carried in PDCCH is then modulated and encoded via encoder 204 to be transmitted by transceiver 206 via antenna 207. UE 211 receives PDCCH and DRX configuration by transceiver 216 via antenna 217. UE 211 obtains PDCCH and DRX configuration via configuration circuit 231, performs DRX operation via DRX circuit 232, and monitors PDCCH via monitor 233 based on the PDCCH and DRX configuration accordingly. UE 211 then demodulates and decodes the downlink control information via decoder 234 for subsequent operation. In one example, the DRX circuit 205 controls a number of DRX timers including an inactivity timer. UE 211 is allowed not restart the inactivity timer if there is no uplink data to transmit, even when UE 211 receives a dynamic uplink grant. As a result, UE 211 is able to enter DRX OFF time and go to sleep earlier to reduce power consumption.

A UE may be configured via radio resource control (RRC) signalling with a DRX functionality that controls the UE's PDCCH monitoring activity. The following definitions may apply to DRX operation in E-UTRAN: 1) on-duration: a duration in downlink subframes in the start of each DRX cycles, during which it is mandatory for UE to monitor PDCCH. If the UE successfully decodes a PDCCH indicating new UL or DL transmission, the UE stays awake and starts the inactivity timer; 2) inactivity-timer: timer length of inactivity timer indicates the time duration in downlink subframes after UE successfully decode a PDCCH indicating a new UL or new DL transmission. The UE shall restart the inactivity timer following a single successful decoding of a PDCCH indicating a new UL or a new DL transmission; 3) active-time: the total duration that the UE is awake to monitor PDCCH. This includes the “on-duration” of the DRX cycle, the time UE is performing continuous reception while the inactivity timer has not expired, and the time UE is performing continuous reception while waiting for a DL retransmission after one HARQ RTT. Based on the above, the minimum active time is of length equal to on-duration, and the maximum active time is undefined.

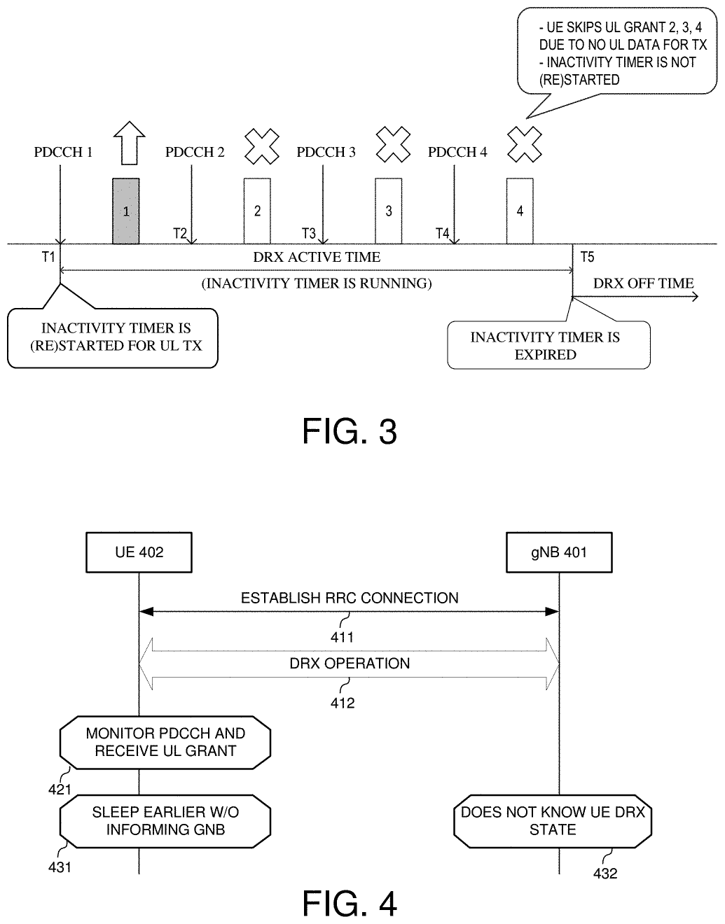

FIG. 3 illustrates a first solution of UE skips UL grants due to no UL data for transmission and UE does not (re)starting of inactivity timer to terminate DRX ACTIVE time and go to sleep earlier. In the example of FIG. 3, UE is configured with DRX operation and is in DRX ACTIVE time at time T1. The UE receives a first PDCCH1 carrying a first uplink grant (UL grant1). The UE transmits data on the UL grant1, and the inactivity timer is (re)started upon receiving PDCCH1. At time T2, the UE receives a second PDCCH2 carrying a second uplink grant (UL grant2). However, at this time, the UE has no UL data available for transmission. Therefore, the UE skips the UL grant2 and the UE does not restart the inactivity timer. Similarly, at time T3 and T4, the UE receives PDCCH3 and PDCCH4, carrying UL grant3 and UL grant4. The UE still has no UL data available for transmission for the UL grant3 and UL grant4. Therefore, the UE skips the UL grant3 and UL grant4 and does not restart the inactivity timer. At time T5, the inactivity timer expires. As a result, the UE enters DRX OFF time and goes to sleep. Because the UE does not (re)start the inactivity timer when there is no UL data available for transmission upon receiving UL grant, the UE is able to terminate the DRX ACTIVE time and go to sleep earlier to save power.

FIG. 4 illustrates a signaling flow between a base station 401 and a UE 402 for not (re)starting inactivity timer upon receiving UL grant during DRX operation for power saving. In step 411, UE 402 establishes an RRC connection with gNB 401 and enters RRC connected mode. In step 412, UE 402 receives RRC configuration for configuring and activating DRX operation. The DRX parameters may include DRX cycle, DRX offset, DRX On-Duration, and DRX Inactivity-Timer, etc. The DRX ON-Duration, Inactivity-Timer, and DL/UL retransmission timer can be configured in number of PDCCH periods, in number of slots, or in an absolute time units (e.g., milliseconds). Furthermore, the gNB can adaptively adjust the DRX parameters based on information including traffic load of each UE, PDCCH repetition number, and PDCCH interval coefficient.

In step 421, UE 402 monitors PDCCH during DRX ON-Duration (e.g., DRX ACTIVE time) and receives UL grants for UL transmission. However, UE 402 has no UL data available for transmission. In step 431, UE 402 decides to go to sleep earlier, e.g., UE 402 does not (re)start the DRX inactivity timer when the UE receives the UL grants and has no UL data available for transmission. As a result, UE 402 may be able to terminate DRX active time after the inactivity timer expires. However, if UE 402 does not inform gNB 401 on the (re)start of the DRX inactivity timer, then gNB 401 does not know UE's DRX state (432).

In the example of FIG. 4, the UE does not (re)start the inactivity timer for a received PDCCH indicating new transmission for uplink if any of the following condition is met: 1) If UE skips this UL grant indicated by the received PDCCH, i.e., UE does not generate a MAC PDU for this UL grant. 2) If UE transmit on the dynamic grant, but the corresponding UL MAC PDU does not include data. For example, the UL MAC PDU does not include a MAC SDU, but only include MAC CE (such as periodic BSR, padding BSR) or padding bits. 3) If UE has skipped continuous n dynamic grants, or continuous n UL grants (including both dynamic grants and configured grants). 4) If UE already continuously skips dynamic grants/uplink grants (including both dynamic grants and configured grants) for a period of time T. The period of time T can be considered since the last time the UE transmit (does not skip) a dynamic grant/uplink grant.

In one embodiment, UE does not (re)start inactivity timer for a received PDCCH indicating new transmission for uplink if the UE has no UL data available for transmission. The criterion for determining UE has no UL data for TX is based on any of the following: 1) If UE has no requirement for uplink transmission, i.e., UE has no data (i.e., MAC SDU) or MAC CE (except for periodic BSR and padding BSR) to transmit, and there is no aperiodic CSI requested for this PUSCH transmission. Note that UE needs not send periodic BSR and padding BSR when there is no other data or MAC CE to transmit. 2) If UE has no requirement for uplink transmission for a period of time. UE can keep a timer for this. The timer is (re)started when UE has no data and MAC CE for transmission. The timer is stopped when UE has uplink data arrival.

In legacy DRX operation, the network (NW) controls when UE can sleep. UE needs to keep awake in DRX active time. When the DRX active time is specified by several DRX timers. If any of on duration timer, inactivity timer, or retransmission timer is running, UE needs to keep awake and cannot sleep earlier. As a result, if NW wants to keep UE awake, e.g., to ensure short packet latency, NW can provide UL grants intensively to frequently restart the inactivity timer. With the inactivity timer running, UE cannot sleep even though UE has no data to transmit. In legacy LTE and NR, when a gNB allows a UE to sleep for power saving, the gNB can send UE a “DRX command MAC CE”. When UE receives a DRX command MAC CE, UE then stop its on duration timer and inactivity timer. As a result, the DRX active time would be finished earlier, and UE can sleep for power saving. Thus, NW can make UE sleep whenever NW wants. But UE cannot sleep whenever it wants.

In accordance with one novel aspect, a framework is proposed to allow UE to request for dynamic DRX active time termination based on UE requirement. For example, a UE can sleep earlier when there is no UL data (e.g., MAC SDU) and gNB persistently provide excessive UL grants. For example, a UE may want to further save power and is willing to sacrifice latency performance. The UE may decide to sleep in an explicit slot (regardless of whether any DRX timers are running at that time). UE may decide to terminate DRX active time after DRX timers controlling active time (on duration timer, inactivity timer, and retransmission timer) are all expired. To avoid extended active DRX active time due to timer restart, the UE can further decide not to restart the inactivity timer unless the UE really has uplink data to transmit. In one embodiment, a UE can send a sync message to inform gNB of “not restarting the inactivity timer”″ or any information for gNB to know when DRX active time would be terminated.

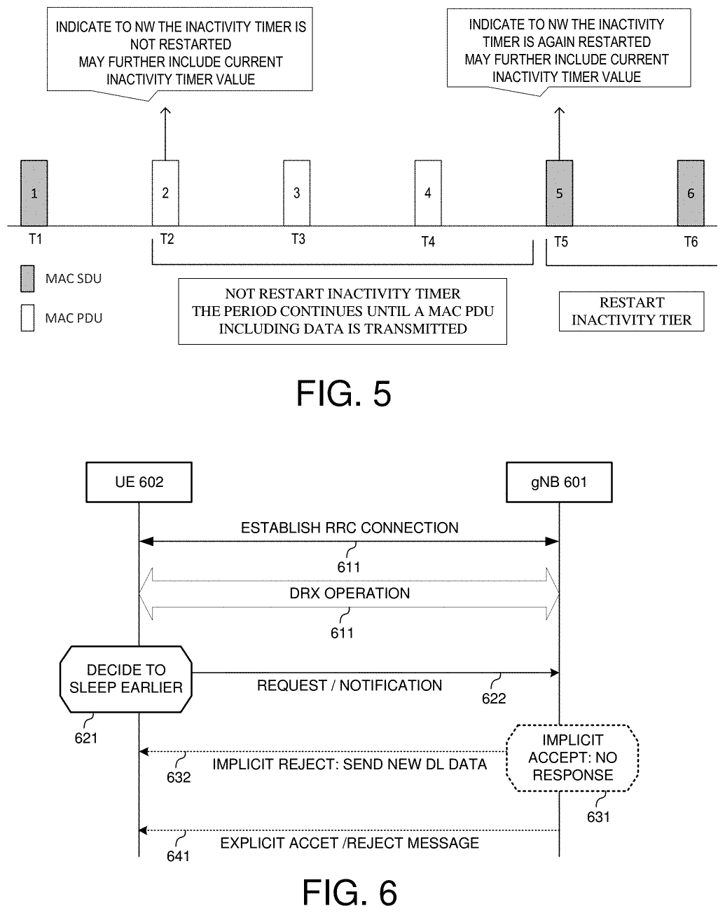

FIG. 5 illustrates a second solution of UE does not (re)starting of inactivity timer upon receiving UL grants and UE provides an explicit indication to the base station for DRX active time. If UE wants to change DRX active time (different from gNB's expectation according to legacy DRX mechanism), UE needs to send sync message or request to gNB. If UE goes to sleep without informing gNB in unexpected DRX active time, transmission from gNB to the UE would fail and gNB would create much retransmission overhead and may think RRC connection of the UE suffer from radio link failure.

In the example of FIG. 5, at time T1, the UE transmits uplink data (MAC SDU) during the DRX active time, while the inactivity timer is running. At time T2/T3/T4, the UE does not restart the inactivity timer (due to the UE has no UL data at time T2/T3/T4), and this period continues until a MAC PDU including data is transmitted. To sync with the network, at time T2, the UE indicates to the network that the inactivity timer is not restarted, the UE may further include current inactivity timer value to the network. At time T5/T6, a MAC PDU with data (MAC SDU) is transmitted, and the UE restarts the inactivity timer. To sync with the network, at time T5, the UE indicates to the network that the inactivity timer is again restarted, the UE may further include current inactivity timer value. A new MAC CE can be introduced to report the inactivity timer value. The MAC CE may include a bit to indicate whether UE has uplink data to transmit or not (or whether UE (re)start inactivity timer for a received PDCCH). The MAC CE further includes a field for gNB to derive the value of UE inactivity timer. NW could also send a request for the inactivity timer value (e.g., via DCI or MAC CE). Upon receiving the request, UE uses this MAC CE to report its inactivity timer value.

FIG. 6 illustrates a signaling flow between a base station and a UE for not restarting inactivity timer during DRX operation with explicit UE request or notification to the network. In step 611, UE 602 establishes an RRC connection with gNB 601 and enters RRC connected mode. In step 612, UE 602 receives RRC configuration for configuring and activating DRX operation. The DRX parameters may include DRX cycle, DRX offset, DRX On-Duration, and DRX Inactivity-Timer, etc. The DRX ON-Duration, Inactivity-Timer, and DL/UL retransmission timer can be configured in number of PDCCH periods. Furthermore, the gNB can adaptively adjust the DRX parameters based on information including traffic load of each UE, PDCCH repetition number, and PDCCH interval coefficient.

In step 621, UE 602 monitors PDCCH during DRX ON-Duration (e.g., DRX ACTIVE time) and receives UL grants for UL transmission. However, UE 602 has no UL data available for transmission. In response, UE 602 decides to go to sleep earlier, e.g., UE 602 does not (re)start the DRX inactivity timer when the UE receives the UL grants and has no UL data available for transmission. In addition to the UE's decision, in step 622, UE 602 sends an explicit request or notification to gNB 601 (e.g., the inactivity timer is not restarted), so that UE and NW can sync on the UE DRX state.

From the network perspective, NW may accept or reject the UE's request, either implicitly or explicitly. Under implicit approach, if request is accepted, NW may not transmit response (step 631). If the request is rejected, NW may send general data to keep UE alive (step 632). Under explicit approach, NW may send an explicit accept/reject message to the UE (step 641). If the request includes specific DRX timer operation, NW may follow it to derive when this UE would enter DRX off time. In one example, UE 602 sends gNB 601 a sleep request or a BSR informing empty buffer in step 622. In one option, gNB 601 can ignore it and UE 602 is still not allowed to sleep unless gNB sends DRX command MAC CE. In another option, the notification may mean that UE 602 would go to sleep several slots automatically later after the sleep request or BSR. If gNB 601 wants to keep UE 602 awake, gNB 601 needs to send an explicit objection to UE 602 for extending the DRX active time.

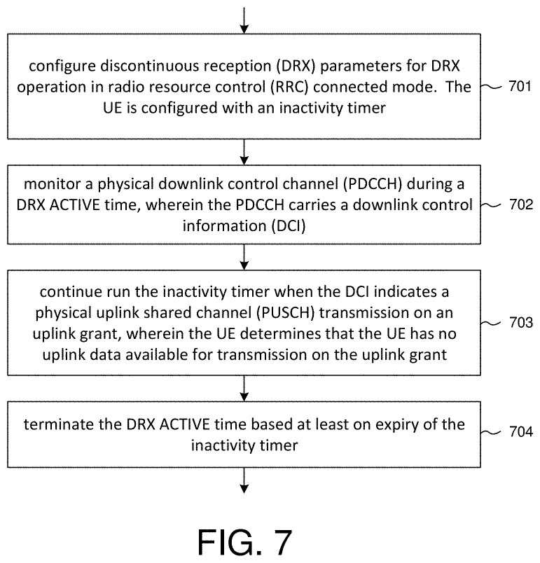

FIG. 7 is a flow chart of a method of enhanced DRX operation for UE power saving in accordance with one novel aspect. In step 701, a UE configures discontinuous reception (DRX) parameters for DRX operation in radio resource control (RRC) connected mode. The UE is configured with an inactivity timer. In step 702, the UE monitors a physical downlink control channel (PDCCH) during a DRX ACTIVE time. The PDCCH carries a downlink control information (DCI). In step 703, the UE continues to run the inactivity timer when the DCI indicates a physical uplink shared channel (PUSCH) transmission on an uplink grant. The UE determines that the UE has no uplink data available for transmission on the uplink grant. In step 704, the UE terminates the DRX ACTIVE time based at least on expiry of the inactivity timer.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
configuring discontinuous reception (DRX) parameters by a user equipment (UE) for DRX operation in radio resource control (RRC) connected mode, wherein the UE is configured with an inactivity timer;
monitoring a physical downlink control channel (PDCCH) during a DRX ACTIVE time, wherein the PDCCH carries a downlink control information (DCI);
continue running the inactivity timer when the DCI indicates a physical uplink shared channel (PUSCH) transmission on an uplink grant for new transmission, wherein the UE determines that the UE has no uplink data available for transmission on the uplink grant; and
terminating the DRX ACTIVE time based at least on expiry of the inactivity timer.

2. The method of claim 1, wherein the determining of UE has no uplink data available for transmission includes at least one of UE performing uplink skipping for the uplink grant, UE performing uplink skipping for the uplink grant and for a number of previous uplink grants, and UE performing uplink skipping for the uplink grant and for a period of time.

3. The method of claim 1, wherein the determining of UE has no uplink data available for transmission includes at least one of UE has no data (MAC SDU) or MAC CE to transmit, UE has no aperiodic CSI requested for the PUSCH transmission, and UE has no aperiodic CSI requested for the PUSCH transmission for a period of time.

4. The method of claim 1, wherein the inactivity timer is started or restarted when the DCI indicates the PUSCH transmission on the uplink grant for new transmission, and wherein the UE has uplink data available for transmission.

5. The method of claim 1, wherein the UE maintains a timer to calculate a duration of the UE has no uplink data available for transmission, wherein the timer is stopped when the UE has uplink data arrival.

6. The method of claim 1, wherein the UE sends an explicit notification to the base station informing an earlier termination of the DRX ACTIVE time.

7. The method of claim 6, wherein the notification is a new MAC control element (CE) or carried by a buffer status report (BSR) with a BSR value equal to 0.

8. The method of claim 6, wherein the UE receives no response from the base station indicating an implicit acceptance of the notification.

9. The method of claim 6, wherein the UE receives new downlink data from the base station indicating an implicit rejection of the notification.

10. The method of claim 6, wherein the UE receives an explicit reply from the base station for accepting or rejecting the notification.

11. A user equipment (UE) comprising:
a configuration circuit that configures discontinuous reception (DRX) parameters for DRX operation in radio resource control (RRC) connected mode, wherein the UE is configured with an inactivity timer;
a receiver that monitors a physical downlink control channel (PDCCH) during a DRX ACTIVE time, wherein the PDCCH carries a downlink control information (DCI); and
a DRX handling circuit that continues to run the inactivity timer when the DCI indicates a physical uplink shared channel (PUSCH) transmission on an uplink grant, wherein the UE determines that the UE has no uplink data available for transmission on the uplink grant, wherein the UE terminates the DRX ACTIVE time based at least on expiry of the inactivity timer.

12. The UE of claim 11, wherein the determining of UE has no uplink data available for transmission includes at least one of UE performing uplink skipping for the uplink grant, UE performing uplink skipping for the uplink grant and for a number of previous uplink grants, and UE performing uplink skipping for the uplink grant and for a period of time.

13. The UE of claim 11, wherein the determining of UE has no uplink data available for transmission includes at least one of UE has no data (MAC SDU) or MAC CE to transmit, UE has no aperiodic CSI requested for the PUSCH transmission, and UE has no aperiodic CSI requested for the PUSCH transmission for a period of time.

14. The UE of claim 11, wherein the inactivity timer is started or restarted when the DCI indicates the PUSCH transmission on the uplink grant for new transmission, and wherein the UE has uplink data available for transmission.

15. The UE of claim 11, wherein the UE maintains a timer to calculate a duration of the UE has no uplink data available for transmission, wherein the timer is stopped when the UE has uplink data arrival.

16. The UE of claim 11, wherein the UE sends an explicit notification to the base station informing an earlier termination of the DRX ACTIVE time.

17. The UE of claim 16, wherein the notification is a new MAC control element (CE) or carried by a buffer status report (BSR) with a BSR value equal to 0.

18. The UE of claim 16, wherein the UE receives no response from the base station indicating an implicit acceptance of the notification.

19. The UE of claim 16, wherein the UE receives new downlink data from the base station indicating an implicit rejection of the notification.

20. The UE of claim 16, wherein the UE receives an explicit reply from the base station for accepting or rejecting the notification.
